(19) United States
(12) Patent Application Publication
(10) Pub. No.: US 2003/0018532 A1
(43) Pub. Date: Jan. 23, 2003

(54) Method and device for conducting mobile commerce

(75) Inventors: Kenneth P. Dudek, Rochester Hills, MI (US); Teck T. Heng, Singapore (SG)

Correspondence Address: ANTHONY LUKE SIMON, General Motors Corporation, 300 Renaissance Center, P.O. Box 300, Mail Code 482-C23-B21, Detroit, MI, 48265-3000, US

(73) Assignee: General Motors Corporation

(21) Appl. No.: 09/911,164

(22) Filed: Jul. 23, 2001

(51) Int. Cl. G06F 17/60

(52) U.S. Cl. 705/17; 705/39

(57) ABSTRACT

The invention provides a method for conducting mobile commerce by verifying user authorization at a hand held device. A transaction request is then transmitted from the hand held device. An amount and a transaction identification is transmitted from a base unit in response to the transaction request. The amount transmitted is displayed at the hand held device. A user identification and the transaction identification are then transmitted from the hand held device and a credit transaction is posted to the user identification from the base unit, as a function of the transaction identification.

### FIELD OF THE INVENTION

In general, the invention relates to the field of communication systems. More specifically, the invention relates to mobile commerce communications and in particular, to transmitting and receiving devices in communication wirelessly with proprietary financial institutions.

### BACKGROUND OF THE INVENTION

Database marketers have contributed significantly to the universal corporate goals of acquiring, retaining, and growing the value of a company's customers. Today, it is routine for firms to use customer transaction data to construct retail trade areas and consumer behavior profiles for the purpose of acquiring new customers. Retention programs, enhanced by modeling, are proactive and can be aimed directly at customers who show a propensity for leaving the company, as opposed to reacting to customers who are long gone. Growth targets for existing customers are established, using real purchase data to spot potential up-sell and cross-sell opportunities.

The most critical step for database marketers, and for the measured marketing process, is to construct a strategy for linking point-of-sale transactions to the individual customer conducting the transaction. The large assortment of electronic payment media available is making it easier to close the loop between customers, sales, and stores. Proprietary and third party credit cards, frequency programs, and stored value cards are continuing to provide a key link.

Many leading firms are adopting new and unique ways to bridge the prior mentioned loop. Mobil or cellular phone technology is now capable of accessing e-commerce Internet sites in order to conduct consumer transactions. These phone systems however are expensive, and some consumers might prefer a simpler, less expensive alternative for mobile commerce.

Another of the more interesting methods in use today is Mobil Oil's Speedpass. This technology uses radio frequencies in the same manner as many tollways do to speed up the toll collection process. Customers register with Mobil and indicate their preferred payment method (e.g. Visa, MasterCard, Mobil Card, etc.). To activate the pump dispenser, customers “wave” the key chain Speedpass device in front of the pump, and their transaction is authorized and recorded. This saves time at the pump for Mobil's customers, and provides Mobil with a valuable database of transactions regardless of a customer's preferred electronic media payment method. A problem arises however, if the customer wishes to use the device with any other system. Automatic toll collection systems, including Mobil Speedpass, only work for the system that they were engineered compliant.

Another innovation is the use of “Smart cards”, a small electronic device about the size of a credit card that contains electronic memory, and possibly an embedded integrated circuit (IC). Smart cards containing an IC are sometimes called Integrated Circuit Cards (ICCs). Smart cards are used for a variety of purposes, including storing a patient's medical records, storing digital cash, and generating network IDs (similar to a token). To use a smart card, to either pull information from it or add data to it, you need a smart card reader for contact smart cards. Contact smart cards have contacts to the semiconductor chip on the surface of the card in compliance with ISO Standard 7816. For contactless smart cards, with no contacts on the surface of the card, connection with the semiconductor is done by means of radio frequency transmission through the surface of the card. Regardless of which smart card type, smart cards often require users to download money into the card prior to transactions, making them more difficult and inconvenient to use. In addition, all of the above mentioned devices require additional information output devices such as printers or monitors in order to view the transaction information prior to its confirmation.

Therefore, it would be desirable to have a device for conducting mobile commerce that provides adequate transaction information, a secure transaction interface, and multiple payment options, all within a convenient and economical unit. Further, it would be desirable that the improved mobile commerce method utilized by the mobile commerce unit, provide for the complexities and problems mentioned or associated with wireless mobile commerce.

### SUMMARY OF THE INVENTION

One embodiment of the invention provides a method for conducting mobile commerce by verifying user authorization at a hand held device. A transaction request is then transmitted from the hand held device. An amount and a transaction identification is transmitted from a base unit in response to the transaction request. The amount transmitted is displayed at the hand held device. A user identification and the transaction identification are then transmitted from the hand held device and a credit transaction is posted to the user identification from the base unit, as a function of the transaction identification.

Another embodiment of the invention provides a system for conducting mobile commerce with means for authorizing a user. The system is further provided with means for transmitting a transaction request from the user, and means for transmitting an amount and a transaction identification in response to the transaction request. Additionally, the system is provided with means for notifying the user of the amount, means for transmitting a user identification and the transaction identification from the user, and finally, means for posting a credit transaction to the user identification, as a function of the transaction identification.

Further, an embodiment of the invention provides a computer readable medium storing a computer program with computer readable code for authorizing a user. The computer readable medium is further provided computer readable code for transmitting a transaction request from a user. Also provided is computer readable code for transmitting an amount and a transaction identification in response to the transaction request, and computer readable code for displaying the amount to the user. Additionally, the computer readable medium is provided computer readable code for transmitting a user identification and the transaction identification from the user. Finally, the computer readable medium is provided computer readable code for posting a credit transaction to the user identification as a function of the transaction identification.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a diagram of one embodiment of a communication system in accordance with the invention;

FIG. 2A is a back view of one embodiment of a wireless communication device of the communication system of FIG. 1;

FIG. 2B is a front view of one embodiment of the wireless communication device of FIG. 2A;

FIG. 3 is a flow chart representation of one embodiment of a method for mobile commerce in accordance with the invention; and

FIG. 4 is a flow chart representation of a further embodiment of a method for mobile commerce, in accordance with the invention.

### DETAILED DESCRIPTION OF THE PRESENTLY PREFERRED EMBODIMENTS

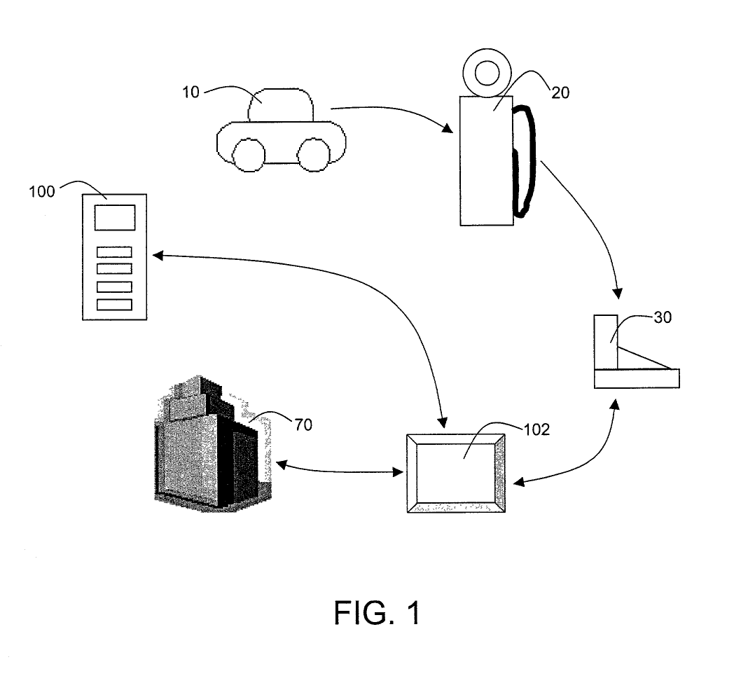

FIG. 1 generally illustrates one embodiment of a communications system for a sale transaction. Illustrated is a typical gasoline purchase transaction for an automobile 10. A customer (user) accesses a service station pump 20 and proceeds to fill the fuel tank of the automobile 10. After deciding if any additional items are needed from within the service station, the customer brings all items to be purchased to a cashier (transaction totaling device) 30. The cashier 30 totals the transaction including the gas purchase and requests the final amount from the customer. In alternative embodiments, the cashier (transaction totaling device) 30 can be of any form known in the art for providing a currency total due from the customer.

The customer, equipped with a hand held device (HHD) 100 for processing electronic transactions, decides to pay for the purchase electronically. In one embodiment, the HHD 100 can be made functional with circuitry, memory, and computer code as is known in the art. The service station, being equipped to handle electronic transactions, has a base unit 102 that is in communication with a financial institution 70. In one embodiment, the base unit 102 can be made functional with circuitry, memory, and computer code as is known in the art. The base unit 102 in the embodiment of FIG. 1 may use a typical modem connection; however, any communication link known in the art may be used.

The transaction proceeds with the customer activating the HHD 100 along with a security measure. The activation, for example, may be accomplished by merely turning the HHD 100 on. The security measure, for example, may include a biometric device, keypad, or any other form known in the art for verifying the customer ID (identification). In another embodiment, a security measure may provide encrypting and/or decrypting all information transmitted and/or received by the HHD 100, the base unit 102, and the financial institution 70. With the customer verified and access authorized, the HHD 100 transmits a signal to the base unit 102 indicating that the customer would like to process the transaction electronically. In the embodiment illustrated, base unit 102 is in communication with the cashier 30. After receiving the initial transmission of the HHD 100, the base unit 102 initiates the payment transaction by broadcasting the payment amount from the cashier 30 and a unique transaction number (ID) to the HHD 100. For one embodiment, the transaction ID acts as a pointer to the actual transaction information. The HHD 100 can display the payment amount received from the base unit 30 on a display feature of the HHD 100, and the customer can decide whether to accept or decline the transaction by activating an accept or decline feature on the HHD 100. It is contemplated that other notification features, including voice indicators may alternatively be used. If unaccepted, the HHD 100 transmits the transaction number and an encoded number that indicates refusal to the base unit 102. The base unit 102 releases the cashier 30 to proceed in a manual mode. In the embodiment of FIG. 1, a button is pressed to accept the transaction on the HHD 100 and the HHD 100 transmits the transaction number and the customers encoded credit card number to the base unit 102. The base unit 102 decodes the number and contacts the financial institution 70. Once connected with the financial institution 70, the base unit 102 can transmit the transaction terms and customer information to the financial institution 70 and wait for an authorization. If authorized, the base unit 102 can post the transaction with the financial institution 70 and clears the transaction from the cashier 30. If unauthorized, the base unit 102 can transmit an error code that the HHD 100 may display. The transaction then returns to its original manual state. At the completion of the transaction, the entire system of FIG. 1 can be returned to its original state of readiness.

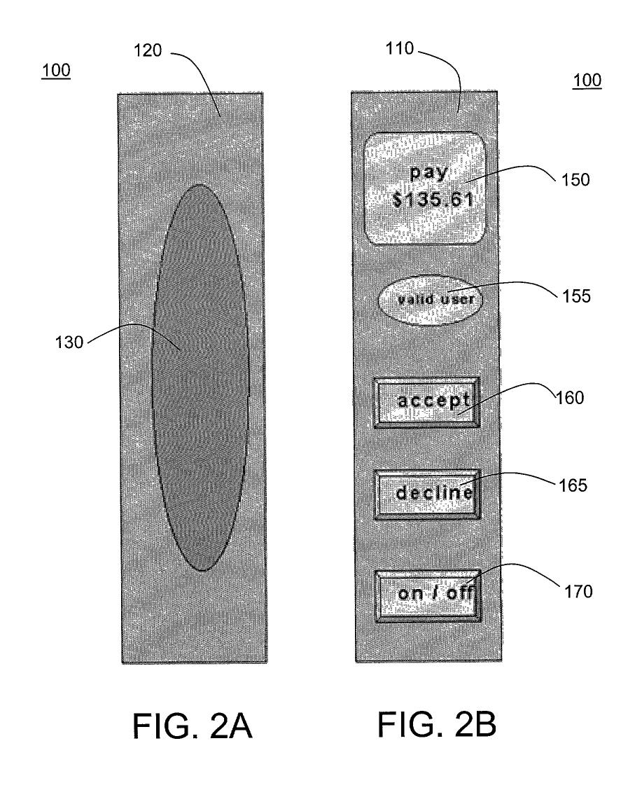

FIG. 2A is a diagram of a back plate of one embodiment of the HHD 100 communication device. FIG. 2B is a diagram of a front plate of one embodiment of the HHD 100 communication device. The hand held device (HHD) 100 can be constructed as a transceiver in accordance with current wireless technologies. One embodiment of the HHD 100 can be provided power by internal batteries, which may be interchanged or recharged via an external power source. Alternative power options known in the art may also be used.

In a preferred embodiment, the size of the HHD 100 may be small enough to be easily transported by a customer yet large enough to prevent being misplaced. For example, the HHD 100 may be the size of a key fob, a credit card, or a miniature garage door opener. In one embodiment of the invention, the basic functioning HHD 100 can include a security identification unit 130, a display 150, a near-range two-way wireless communication circuit (not shown), and an inexpensive processor and memory or special purpose circuitry and memory (not shown) as is available and known in the art.

The security identification unit 130 for the embodiment of FIG. 2A is a biometric thumbprint scanner as is known in the art, and can be located on the bottom 120 of the HHD 100. Alternative embodiments of the HHD 100 may use alternative identification techniques, which can include a keyed personal identification number (PIN), voice recognition, iris scanning, or a combination of identification techniques known to the art, with the interactive functionality (keys, scanner, etc.) located anywhere on the HHD.

The display 150 of the embodiment of FIG. 2B can be a liquid quartz display, or any alternative display as is known in the art capable of displaying a predetermined minimum of alphanumeric and/or custom characters. The display 150 may or may not be backlit, luminescent, or in some way identifiable in less then viewable light.

The secondary or enhanced functioning of the FIG. 2B embodiment of HHD 100 can further include a valid user diode 155, an accept button or touch pad 160, a decline button or touch pad 165, and a power on/off button or touch pad 170, all located on the top 110 portion of the HHD 100. Alternative embodiments of the invention may require additional, reduced, or alternative secondary functionality, which may be physically located in alternative configurations.

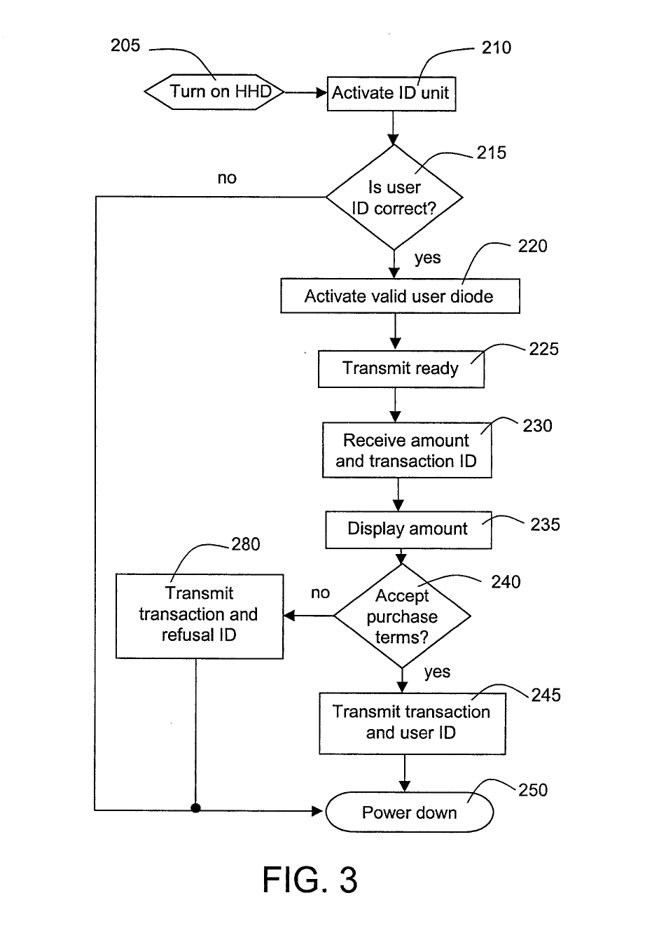

Another embodiment of a communication device in accordance with the invention includes the base unit 102 that has the capability to communicate wirelessly with compatible HHD devices over short distances. In one embodiment, the base unit 102 may additionally include the ability to communicate with financial institutions, the ability to authorize customer purchases, the ability to post or otherwise process customer purchases, and the ability to perform the processing tasks submitted by the compatible HHD described by the FIG. 3 flow chart detailed below.

The FIG. 3 flow chart representation of one embodiment of a mobile commerce method for the HHD 100 begins with the activation 205 of the HHD 100, and security ID 210. For this embodiment, the customer presses the “on” key 170 and places their thumb over the biometric identification unit 130. If the customer ID is verified 215, the user diode 155 can be activated 220 and indicate to the customer that the unit is ready for a transaction. If the customer ID is not verified, the HHD can be powered down 250.

The HHD 100 can transmit that it is in a ready to communicate mode 225 to any listening base unit 102. If a base unit 102 is within range, a transaction amount and transaction ID can be received 230 by the HHD 100, and the transaction amount can be displayed 235 on the display 150. The customer may now accept or deny the purchase terms 240 by pressing the accept 160 or decline 165 buttons on the HHD 100. An alternative single button embodiment may require the user to press once to decline and twice to accept. If the customer accepts the purchase terms, the HDD 100 can transmit the previously received transaction ID and a secured user ID 245. In one embodiment, the secured user ID can be an encrypted credit card number, but other forms of user account and/or credit information may be used. Once the transaction ID and user ID have been transmitted, the HHD 100 can power down 250 until needed again for the next transaction. If the purchase terms had been denied 240, the transaction ID and a refusal ID can be transmitted to the base unit 102, and the HHD 100 may again power down 250.

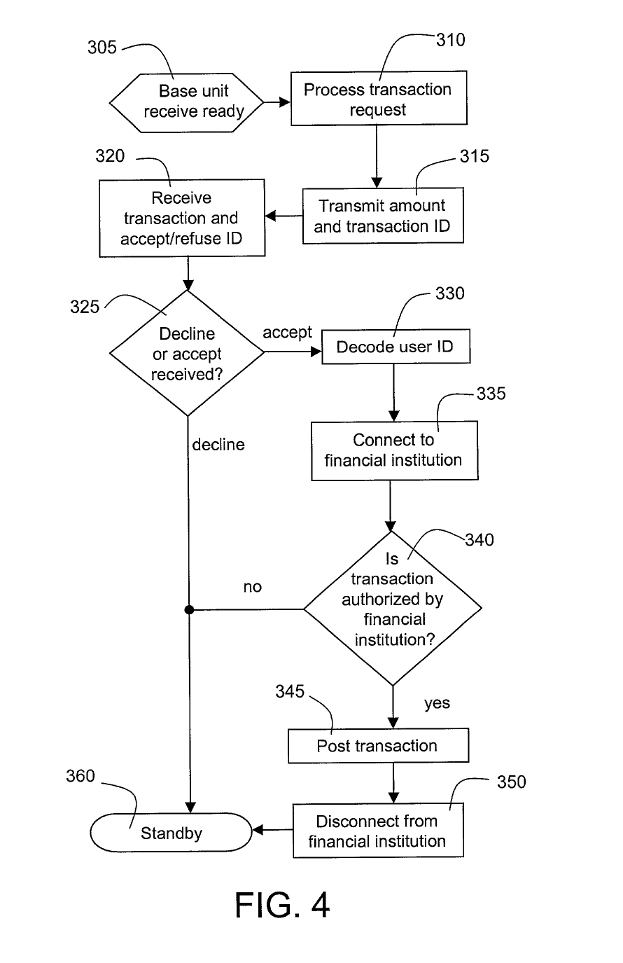

One embodiment of a method for using the base unit 102 for mobile commerce is described in the FIG. 4 flow chart. First, the base unit 102 can receive a ready transmission 305 from a compatible HHD 100. The base unit 102 can receive a transaction request 310 and transmit or broadcast 315 a payment amount and a unique transaction number (ID) to the HHD 100. The base unit 102 can remain in a standby mode while the customer decides whether to accept the transmitted terms of the transaction. The base unit 102 can eventually receive 320 the identical transaction ID as was sent in box 315, and an accept code (user ID) or refuse ID as is transmitted from the HHD 100. The transaction ID can be used to verify this particular transaction over any other concurrent transaction. If the HHD 100 transmitted a refusal ID 325, the base unit can return to a standby mode 360, waiting for the next ready transmission 305. If the HHD 100 transmitted an accept code 325, the base unit 102 can decode the transmitted user ID 330 to determine account and/or payment information.

The base unit 102 can next connect with a financial institution 335 for further processing of the transaction. The base unit 102 can request an authorization from the financial institution 340 for this transaction and this user prior to transmitting the information to be posted. If authorized, the transaction information can be transmitted and posted 345. If not authorized, the transaction information can be deleted from the queue and the base unit 102 can be returned to a standby mode 360. After posting the transaction information, the base unit 102 can disconnect from the financial institution 350 and return to a standby mode 360, waiting for the next ready reception 305.

One embodiment of the invention provides that spread spectrum technology may be used to ensure security of the inter-device transmissions. Alternatively, a rolling code scheme similar to those used on newer garage-door openers can be used.

The present invention may be embodied in other specific forms without departing from its spirit or essential characteristics. The described embodiments are to be considered in all respects only as illustrative and not restrictive.

We claim

1. A method for conducting mobile commerce comprising:
verifying user authorization at a hand held device;
transmitting a transaction request from the hand held device;
transmitting an amount and a transaction identification in response to the transaction request, from a base unit;
displaying the amount at the hand held device;
transmitting a user identification and the transaction identification from the hand held device; and
posting a credit transaction to the user identification from the base unit, as a function of the transaction identification.

2. The method of claim 1 wherein the hand held device provides for interactive communication with the base unit.

3. The method of claim 1 wherein user authorization is verified using a biometric device.

4. The method of claim 1 wherein user identification contains credit card information.

5. The method of claim 1 further comprising:
encrypting the user identification at the hand held device prior to transmitting.

6. The method of claim 1 further comprising:
decrypting the user identification at the base unit.

7. The method of claim 1 further comprising:
initializing communication from the base unit to a financial institution.

8. The method of claim 1 further comprising:
encrypting the transaction identification from the base unit prior to transmitting.

9. The method of claim 1 further comprising:
decrypting the transaction identification at the financial institution.

10. The method of claim 1 wherein transaction identification is used as a pointer to actual transaction information.

11. The method of claim 1 further comprising:
initializing communication from the base unit to a transaction totaling device.

12. The method of claim 1 further comprising:
accepting a transaction from the hand held device, based on the displayed amount.

13. A system for conducting mobile commerce comprising:
means for authorizing a user;
means for transmitting a transaction request from the user;
means for transmitting an amount and a transaction identification in response to the transaction request;
means for notifying the user of the amount;
means for transmitting a user identification and the transaction identification from the user; and
means for posting a credit transaction to the user identification as a function of the transaction identification.

14. The system of claim 13 further comprising:
means for initiating communication to a transaction totaling device.

15. The system of claim 13 further comprising:
means for initiating communication to a financial institution.

16. The system of claim 13 further comprising:
means for allowing a user to accept a transaction based on the displayed amount.

17. A computer readable medium storing a computer program comprising:
computer readable code for authorizing a user;
computer readable code for transmitting a transaction request from a user;
computer readable code for transmitting an amount and a transaction identification in response to the transaction request;
computer readable code for displaying the amount to the user;
computer readable code for transmitting a user identification and the transaction identification from the user; and
computer readable code for posting a credit transaction to the user identification, as a function of the transaction identification.

18. The computer readable medium of claim 17 further comprising:
computer readable code for initiating communication to a transaction totaling device.

19. The computer readable medium of claim 17 further comprising:
computer readable code for initiating communication to a financial institution.

20. The computer readable medium of claim 15 further comprising:
computer readable code for accepting a transaction from the user, based on the displayed amount.
